(19) United States
(12) Patent Application Publication
(10) Pub. No.: US 2015/0120865 A1
(43) Pub. Date: Apr. 30, 2015

(54) METHOD FOR CONTROLLING CONTENT DATA RECEIVING THROUGH A PLURALITY OF CONNECTED WIRELESS NETWORKS AND AN APPARATUS FOR SAID METHOD

(71) Applicant: AIRPLUG INC., Seoul (KR)

(72) Inventors: Seung Jun Lee, Seoul (KR); Soon Uk Kim, Anyajng-si (KR)

(73) Assignee: AIRPLUG INC., Seoul (KR)

(21) Appl. No.: 14/404,962

(22) PCT Filed: Jun. 7, 2013
(86) PCT No.: PCT/KR2013/005038

§ 371 Date: Dec. 2, 2014

(30) Foreign Application Priority Data
Jun. 14, 2012 (KR) 10-2012-0063831

(51) Int. Cl. H04W 4/18; H04L 29/08; H04W 28/02

(52) U.S. Cl. CPC H04W 4/18; H04W 28/0236; H04W 28/0215; H04L 67/02; H04W 88/06
USPC 709/217

(57) ABSTRACT

A wireless terminal of the present invention determines a section to be skipped on data of a selected content from the last position of unprocessed data based on information about dynamic state of the unprocessed data that has been received but is not played yet, if a requirement for using the second wireless network is satisfied while media data of the selected content is being received from an external server through the first wireless network. After determination of the section to skip, the wireless terminal transmits a transfer request demanding data right after the determined section to the external server through the second wireless network.

### TECHNICAL FIELD

The present invention relates to a method for receiving content data using a plurality of wireless networks, in particular, a plurality of connected heterogeneous networks, each of which providing a service coverage being different in characteristics or quality and so on from that of the others, and relates to an apparatus for the method.

### BACKGROUND ART

As mobile communication networks are advanced, users are now able to search for various kinds of needed information through browsing, and view desired contents after download or in a streaming way regardless of their current location by using a wireless terminal such as a smart phone, a tablet computer, and the like, not to mention a mobile phone.

In particular, as the performance of a radio communication infrastructure and a wireless terminal is further improved, a variety of high-quality video contents, for example, live sports broadcasts, news, music show and so on are being now provided in streaming manner which does not require downloading time.

The radio communication service is highly variable in its quality spatially or temporally. Thus, even though receiving of a high-quality video contents through a connected wireless network is in good progress, the current stable quality may not be kept in case of moving or as the time goes by.

In general, a wireless terminal is equipped with wireless communication resources capable of connecting to a plurality of heterogeneous networks that are constructed by different communication infrastructure. If multiple connections (In this specification, the term of “multi-connected state” is used to mean the state where a data service is available by using a plurality of networks at the same time with multiple access IP addresses that are allocated respectively from the plurality of networks) were used with the wireless communication resources, the variability could be complemented by using other network although the quality of wireless data service provided by one network changes. For example, in even case that the speed to receive remote data through one network is decreased, an overall speed to receive remote data can be stably maintained above the speed required for playing a corresponding content by proceeding to receive remote data through another connected network, too.

The data services provided respectively by the plurality of heterogeneous networks may be different in service fee to be charged to users for the same data usage because of communication policy or service billing policy and so on of a mobile communication operator who is providing a mobile communication service. For example, the Wi-Fi LAN (called as ‘Wi-Fi’ network hereinafter) provides wireless service for free on the ground that its service zone is scattered and narrow while data service through the cell-type of mobile telephone communication network (called as ‘cellular network’ hereinafter) is charged for its usage. Under such data service providing environment, if the Wi-Fi network becomes available while viewing a remote content being streamed from an arbitrary server with a wireless terminal connected to the cellular network, data of the remote content to be viewed may be received complementarily through the available Wi-Fi network in the multi-connected state or a network being used to receive content data is replaced from the cellular network to the Wi-Fi network in that state. The use of Wi-Fi network in complementary or replacing manner may reduce fee of data usage to be charged to a user for viewing the remote content.

By the way, in the situations like the above example, if another connected network is to be alternatively or additionally used in the multi-connected state to receive content data that is being received through one connected network, a position from which content data is requested through said another connected network must be determined first. Improper determination of a data position may cause an inconvenient situation to a user where video being streamed is stopped or played discontinuously.

### DISCLOSURE

### Problem to be Solved

One object of the present invention is to provide a data reception controlling method and apparatus for determining a position of remote data to request from through a newly-connected wireless network so that multiple connections may be fully utilized in data receiving as preventing data of content being received and played currently from being depleted.

Another object of the present invention is to provide a data reception controlling method and apparatus for determining a position of remote data to request from through an additionally-used wireless network so that plural networks may be used together in consideration of cost to be burdened to a user according to network usage as preventing data of content being received and played currently from being depleted.

A yet another object of the present invention is to provide a data reception controlling method and apparatus for using multiple connections most optimally in view of users by determining a position of remote data to request from through a newly-used wireless network in the multi-connected state in such a manner that the position is adaptively determined according to the current buffered state of data to be played or a factor affecting the buffered state.

The scope of the present invention is not necessarily limited to the above explicit statements. Rather, the scope of the present invention covers anything to accomplish effects that could be derived from the specific and illustrative explanations of the present invention below.

### Technical Solution

A wireless terminal for accessing a plurality of wireless networks in accordance with an aspect of the present invention, comprises: a receiver configured to receive media data from an external server through at least one connected wireless network, and provide the received data to a processing unit for decoding media data; and a controller configured to conduct a first operation and a second operation if a requirement for using a second wireless network is satisfied while the receiver is receiving media data of a selected content from the external server through a first wireless network, wherein the first operation is to determine a section to be skipped from a last position of unprocessed data based on information about dynamic state of the unprocessed data that has been received by the receiver but is not decoded yet, and the second operation is to cause a transfer request, demanding data next to the determined section, to be transmitted to the external server through the second wireless network.

In the first embodiment of the present invention, the second wireless network requires no cost to a user or a smaller cost, excluding a fixed cost, than the first wireless network when the second wireless network is used for data service. In the present embodiment, the controller is configured to determine size of the section based on an amount of the unprocessed data that is indicated by the information about the dynamic state in such a manner that the size of the section is smaller in case of the amount of the unprocessed data being large than in case of the amount of the unprocessed data being small.

In the first embodiment, the controller may determine the size of the section to be zero if the amount of the unprocessed data is larger than a threshold.

In addition, in the above-mentioned first embodiment, the controller may be further configured to conduct, in case that the amount of the unprocessed data is smaller than a threshold, an operation of checking data speed being received through the first wireless network and finding a compensating value based on the checked data speed; and an operation of reflecting the found compensating value to adjust the size of the section determined based on the amount of the unprocessed data. In this case, the controller may find, in case of the checked data speed being lower than a first reference, the compensating value in such a manner that the size of the section is less decreased in case of the checked data speed being high than in case of the checked data speed being low when the compensating value is applied to adjust the size.

Furthermore, in the above-mentioned first embodiment, the controller may be further configured to conduct, in case that data speed being received through the first wireless network is higher than a threshold, an operation of finding a compensating value based on an expected service speed of the second wireless network; and an operation of reflecting the found compensating value to adjust the size of the section determined based on the amount of the unprocessed data. In this case, the controller may find, in case of the expected service speed being lower than a second reference, the compensating value in such a manner that the size of the section is less increased in case of the expected service speed being high than in case of the expected service speed being low when the compensating value is applied to adjust the size. In addition, the controller figures out the expected service speed from information received from an external server by providing identifying information of an access point of the second wireless network to the external server using a preset access address, or from information on receiving speeds, each of which was previously stored in the wireless terminal when the wireless terminal used data service provided through the second wireless network.

In the above-mentioned first embodiment, switching from a disconnected state to the second wireless network to a connected state thereto corresponds to the requirement for using the second wireless network.

In the second embodiment of the present invention, the first wireless network requires no cost to a user or a smaller cost, excluding a fixed cost, than the second wireless network when the first wireless network is used for data service. In the present embodiment, the controller is configured to determine size of the section based on change rate of an amount of the unprocessed data that is indicated by the information about the dynamic state in such a manner that the size of the section is smaller in case of the change rate being a specific value than not in the case, the specific value being a rate at which the amount of the unprocessed data decreases faster than a threshold speed.

In the second embodiment, a first requirement that the amount of the unprocessed data is smaller than a threshold corresponds to the requirement for using the second wireless network. And, a second requirement that the change rate of the amount of the unprocessed data is a value, which indicates that the amount of the unprocessed data does not increase faster than a reference speed, may also correspond to the requirement for using the second wireless network. In this case, the controller conducts both the first operation and the second operation in case that the first requirement and the second requirement are satisfied together. If the first requirement is satisfied but the second requirement is not, the controller may change the threshold to a smaller value.

In addition, in the above-mentioned second embodiment, the controller may conduct, based on a control value of a pre-allocated specific variable, both the first operation and the second operation automatically if the requirement for using the second wireless network is satisfied.

In one embodiment of the present invention, the controller is further configured to stop, if a first data section demanded by the transfer request and a second data section are duplicated, receiving yet-unreceived data to follow a position from which the second data section is duplicated with the first data section, the second data section having been demanded by a previous request that was transmitted for receiving the media data through the first wireless network.

In the aforementioned wireless terminal and various embodiments according to the present invention, the controller converts, if a necessary physical quantity is given as a time value when determining the section, the time value to a equivalent amount of data based on mutual ratio between entire size of the selected content and playback duration thereof, and applies the converted amount of data to determine the section.

A method for controlling data receiving in a state of multiple connections to wireless networks in accordance with another aspect of the present invention, comprises: requesting an external server for media data of a selected content through a first wireless network; providing the media data being received in response to the request to a processing unit for decoding media data; determining, if a requirement for using a second wireless network is satisfied, a section to be skipped on data of the content from a last position of unprocessed data based on information about dynamic state of the unprocessed data that has been received but is not decoded yet by the processing unit; and causing a transfer request demanding data next to the determined section to be transmitted to the external server through the second wireless network.

An apparatus for providing a program stored in a storage in accordance with still another aspect of the present invention, comprises: communication means being capable of transceiving data with an outside entity; and a storing unit storing an application, to be run on a wireless terminal, that is transmitted through the communication means. And the application includes program structures to accomplish functions, in case of being run on the wireless terminal, that comprise: a function of receiving from an external server media data through at one or more connected wireless networks and providing the received media data to a processing unit for decoding media data; a function of determining a section to be skipped on data of a selected content from a last position of unprocessed data based on information about dynamic state of the unprocessed data that has been received but is not decoded yet by the processing unit, if a requirement for using a second wireless network is satisfied while media data of the content is being received from the external server through a first wireless network; and a function of causing a transfer request demanding data next to the determined section to be transmitted to the external server through the second wireless network.

### Advantageous Effects

While playing data of a content being received through one wireless network, the above-explained present invention or at least one embodiment of the present invention to be explained in detail hereinafter in reference to accompanied drawings uses another wireless network, which imposes no cost for using its data service or a smaller cost than said one wireless network, as preventing current content play from being interrupted if said another wireless network is available. In a different communication environment, embodiments of the present invention additionally use another wireless network with high reliability in wireless service although service fee may be charged for using the network additionally if the received data is expected to be insufficient. However, even in such case, the embodiments control the amount of data over the additionally-using wireless network to be not great, if possible, in consideration of urgency of remote data to keep seamless play.

Therefore, users, who are viewing a content being played by a wireless terminal in which control of multiple connections is embedded according to the present invention, are able to fully enjoy viewing remote content seamlessly while cost burden due to data usage is minimized.

### DESCRIPTION OF DRAWINGS

FIG. 1 illustrates, as seen from the programming point of view, a logical structure of related elements, which constitute a wireless terminal that an embodiment of a method for controlling to receive content data in a state of multiple connections to a plurality of wireless networks is implemented in, and external entities connected to the wireless terminal according to the present invention;

FIG. 2 illustrates a structure of a wireless terminal according to one embodiment of the present invention in which a method for receiving media data while controlling to receive content data in a state of multiple connections to a plurality of wireless networks is implemented;

FIG. 3 illustrates a structure of a media player, together with a part of related elements in a wireless terminal, to receive and decode media data while controlling to receive content data in a state of multiple connections to a plurality of wireless networks according to one embodiment of the present invention;

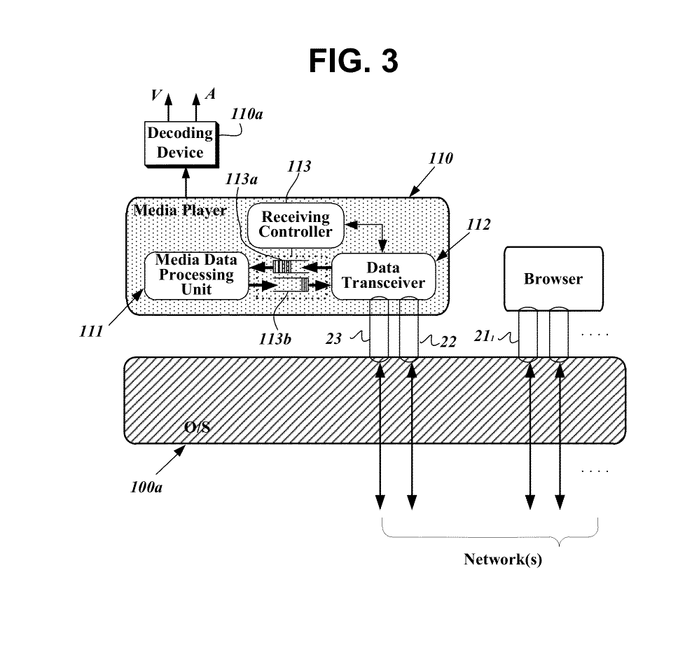

FIGS. 4 and 5 illustrate structures for buffering the received data until it is decoded to be played according to embodiments of the present invention;

FIG. 6 is an example of a flow diagram illustrating one method for controlling to receive data in the process of switching from the single-network using state to the multi-network using state under multiple connections according to one embodiment of the present invention;

FIG. 7 shows a figure to explain the method where a position from which data is requested through a network being used additionally besides the currently-using network is determined to be skipped from the last position of currently-received data according to one embodiment of the present invention;

FIG. 8 shows an example of a rule, according to one embodiment of the present invention, that a skip section to jump over is determined on the basis of the currently buffered amount of received data in the case that a wireless network to used additionally is the Wi-Fi network;

FIG. 9 shows an example of a request document, prepared in compliance with communication protocol to be transmitted through an additionally-using wireless network, which demands a section following currently received data according to one embodiment of the present invention;

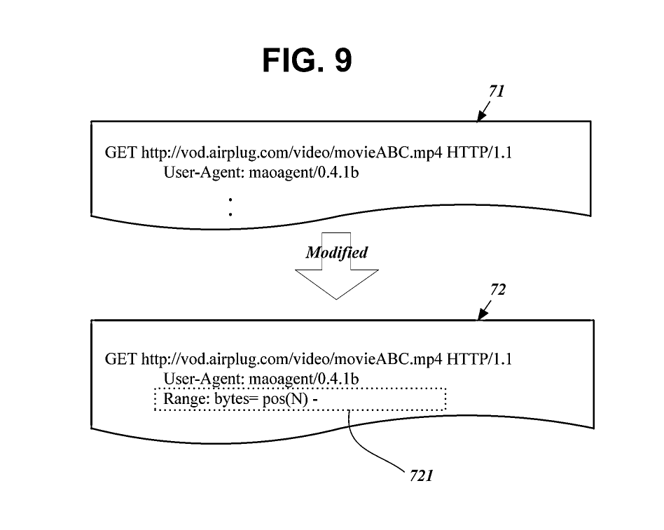

FIG. 10 shows schematically the process according to the present invention where in the multi-network using mode, data of a selected content is divided into segments, the request documents demanding the divided segments respectively are transmitted through sockets that are created for a plurality of networks, and the information required for arranging the received segments in their order is stored in connection with individual sockets;

FIG. 11 shows an example of a rule, according to one embodiment of the present invention, that a skip section determined depending upon the current amount of buffered data is adjusted in size on the basis of service speed of the currently-used network in the case that a wireless network to used additionally is the Wi-Fi network;

FIG. 12 shows an example of a rule, according to the one embodiment of the present invention, that a skip section determined depending upon the current amount of buffered data is adjusted in size on the basis of expected speed of the Wi-Fi network that is to be used additionally; and

FIG. 13 shows an example of a rule, according to one embodiment of the present invention, that a skip section to jump over is determined on the basis of the current change rate of the amount of buffered data (or data receiving speed) in the case that a wireless network to be used additionally is the cellular network.

### MODE FOR INVENTION

In what follows, various embodiments according to the present invention will be described in detail with reference to the appended drawings.

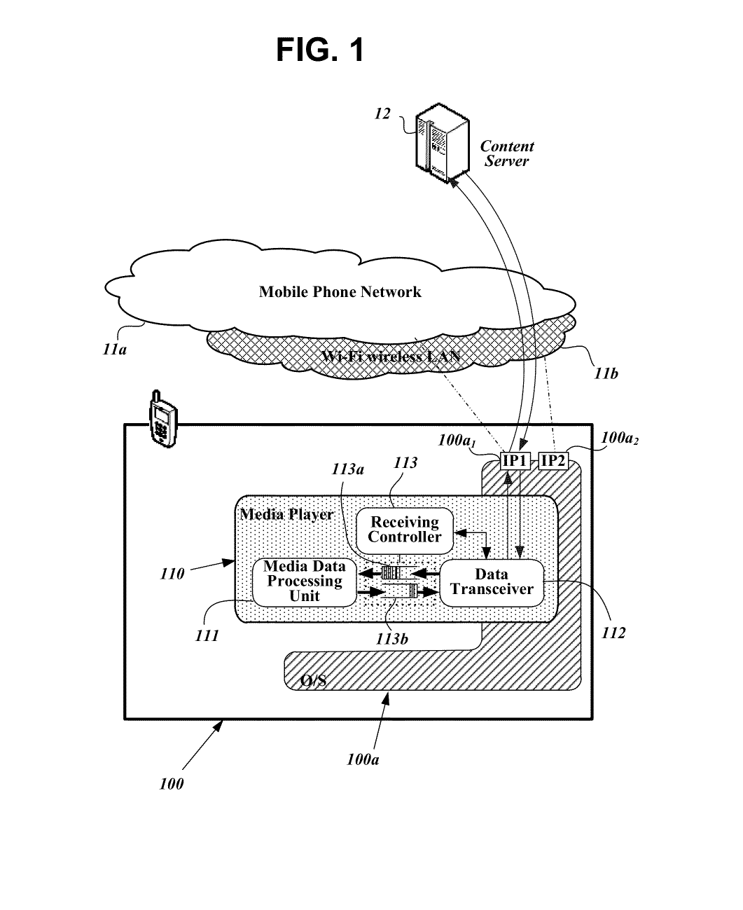

FIG. 1 illustrates, as seen from the programming point of view, a logical structure of related elements, which constitute a wireless terminal that an embodiment of a method for controlling to receive content data in a state of multiple connections to a plurality of wireless networks is implemented in, and external entities connected to the wireless terminal according to the present invention.

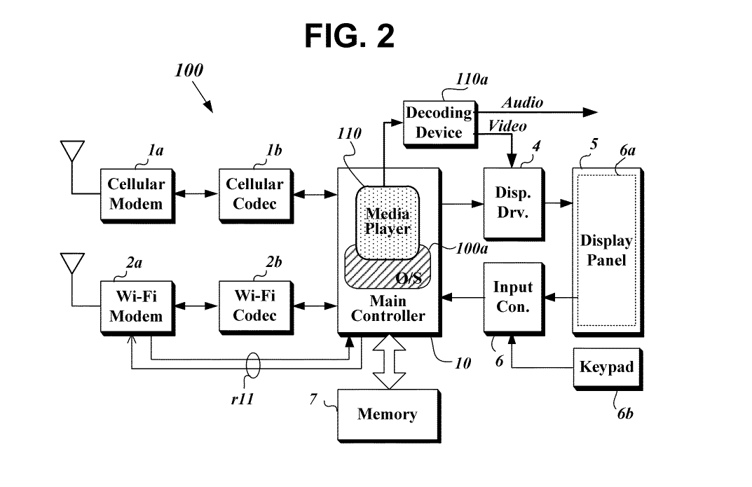

The logical structure of the wireless terminal 100 illustrated in the figure from the programming point of view comprises a conventional operating system such as Android, IOS, and Windows or an operating system 100a specific to the present invention that is intended for driving hardware resources (illustrated in FIG. 2) of the wireless terminal 100 and exchanging appropriate signals and/or information with the corresponding resources; and a media player 110 to be executed based on the operating system 100a. Besides the media player 110, various other applications (hereinafter, application may be called ‘app’ for short) can be implemented based on the operating system 100a; however, since they are not necessary to describe the technical principles, spirit and scope of the present invention, other conventional applications will not be described herein. The operating system 100a can obtain access IP addresses for data services from wireless communication networks which can be utilized with hardware resources of the wireless terminal 100, and use the obtained IP addresses jointly. FIG. 1 illustrates a situation where the operating system 100a receives IP1 100a₁ from the cellular network 11a, which one of public mobile phone networks, and IP2 100a₂ from the Wi-Fi network 11b, respectively and configures the wireless terminal 100 with the obtained IP addresses. Depending on the needs or network accessibility, the operating system 100a may be configured with a single access IP address.

The media player 110 shown in the figure is a process or an app implemented or installed in the wireless terminal 100 and it can be provided in the form of software having a program structure consisting of command codes to be executed based on the operating system 100a as shown in FIG. 1. In case the media player 110 is provided in the form of software, the media player 110 stored in a high-capacity storage means of a particular server may be downloaded into the wireless terminal 100 through a conventional on-line purchasing process from the particular server connected to a communication network, and then executed in the terminal 100. Depending on situations, at least a part of functions of the media player 110 to be described in detail below may have been embedded in the wireless terminal 100 in the form of middleware, a platform which apps run based on, or a part of the operating system 100a. Also, if a hardware component is incorporated into the media player 110, it can perform a part of the functions of the media player 110 that are described in detail below. Therefore, the scope of the present invention should not be limited by what type of resources or configuration is used to implement the media player 110, the structure and operations of which are described in detail through various embodiments according to the present invention.

In one embodiment according to the present invention, the media player 110 comprises, as individual sub-processes, a media data processing unit 111 for decoding the received media data of a content; and a data transceiver 112 for creating a communication socket through an API (Application Program Interface) provided by the operating system 100a and communicating data, which is exchanged to and from the media data processing unit 111, with an external entity through the created socket. The media player 110 further comprises, as a sub-process, a receiving controller 113 which allocates or creates a receiving buffer 113a and transmission buffer 113b to be used as a data channel for data transmission or exchange between the media data processing unit 111 and the data transceiver 112, and controls to receive remote data on the basis of the buffered state of the receiving buffer 113a. The receiving controller 113 keeps monitoring the buffered state.

In another embodiment according to the present invention, the transmission buffer may not be employed. In the present embodiment, the media data processing unit 111 provides the data transceiver 112 with data or requests, which are to be transmitted to an external server according to the user's request, by way of parameters, etc. and the data transceiver 112 prepares a request compliant with communication protocol, for example, an HTTP Request with reference to information carried by the parameters and transmits the prepared request. In another embodiment according to the present invention, a UI processing unit intended for a function to process user commands may be implemented as an independent process that is separated from the media data processing unit 111. In the present embodiment, the UI processing unit provides the data transceiver 112 with data or requests to be transmitted to an external server according to the user's request through parameters, etc.

The data transceiver 112 identifies which wireless network can be accessed among a plurality of heterogeneous wireless networks 11a, 11b through the operating system 110a, and communicates data with an external server 12 by using an accessible communication network relevant to the present operating condition. The receiving controller 113 ensures continuity of content being played even in case of changing the network using method, for example, switching between the single-network using and the multi-network using. For ensuring data to be continuously buffered into the receiving buffer 113a even in the middle of the change, the receiving controller 113 performs the operations of generating a required request compliant with communication protocol, for example, an HTTP Request for each segment of media data and transmitting the generated requests as distributing them over communication networks or concentrating them in a single communication network through the data transceiver 112. Such operations will be described below. The media data processing unit 111 can also generate a request compliant with communication protocol according to the user's request and delivers the generated request to the data transceiver 112 through the transmission buffer 113b, thereby transmitting the generated request to the external server 12.

In one embodiment according to the present invention, the data transceiver 112, the media data processing unit 111, and the receiving controller 113 can be implemented together as a single process to be run based on the operating system 100a. In this case, exchange of information or data among them can be carried out by using global variables, local variables, or arguments and/or return values of local functions. Therefore, the concept, subject matter, and aimed effects of the present invention do not necessarily presume or require that the data transceiver 112, the media data processing unit 111, and the receiving controller 113 have to be separated from each other and implemented as separated individual processes, but they can be also practiced or achieved even when individual functions described below are implemented in the form of a single process.

The wireless terminal 100 structured logically illustrated in generally comprises such hardware components as shown in FIG. 2 and it may be any one of a smart phone, tablet computer, and a notebook computer equipped with a function of a mobile phone that are capable of accessing all of a public cellular network and a Wi-Fi network, and so on. To provide specific descriptions of the block diagram in the figure, the wireless terminal 100 comprises a cellular modem 1a (which includes a module for processing RF signals) for communicating with the cellular network 11a by modulating or demodulating a signal in compliance with the signaling system specified by the cellular network 11a; a cellular codec 1b for encoding data or decoding encoded data in compliance with communication protocol adopted for the cellular network 11a; a Wi-Fi modem 2a (which includes a module for processing RF signals) for communicating with the Wi-Fi network 11b by modulating or demodulating signals in compliance with the signaling system specified by the Wi-Fi network 11b; a Wi-Fi codec 2b for encoding data or decoding encoded data in compliance with communication protocol adopted for the Wi-Fi network 11b; a display panel 5 for visual display of an image, characters, and so on; a display driving unit 4 for driving the display panel 5 for arbitrary data to be displayed visually onto the display panel 5; a decoder 110a for decoding input encoded image and audio data and outputting the decoded image and audio data as visual and audible signals; a touch sensor 6a attached at the front of the display panel 5; a keypad 6b equipped with keys and/or buttons; an input control unit 6 for sensing a user input and/or selection applied to the touch sensor 6a and keypad 6b, and outputting input information in accordance with the sensed result; a main controller 10 for communicating data with the above-mentioned elements or controlling them to carry out operation according to the input information outputted from the input control unit 6 or controlling the display driving unit 4 to provide a user interface (UI) intended for receiving the user's selection; and a memory 7 providing data storage space required for operations of the main controller 10.

The main controller 10 enables the operating system 100a to perform intended functions by executing given command codes, and also by executing command codes of the media player 110, it enables the media player 110 to carry out operations that are described in detail hereinafter. In particular, the media data processing unit 111 of the media player 110, if needed, can apply the decoding operation performed in hardware by the decoder 110a to encoded image or audio data blocks through an appropriate API (Application Program Interface) provided by the operating system 100a.

The structure of the wireless communication terminal 100 illustrated in FIG. 2 is only an example intended to describe embodiments of the present invention in a specific and illustrative manner to help understanding of the concept and subject matter of the present invention. The wireless terminals implementing the concept and subject matter of the present invention can further include elements to provide various functions not shown in FIG. 2 or exclude one or more of the illustrated elements and moreover, a hardware element can be implemented by software and vice versa.

In what follows, described will be a process of controlling to receive data of a remote content in a state of multiple connections to wireless networks that is carried out by the wireless terminal 100, the logical structure of which is illustrated around the media player 110 in FIG. 1.

First, a user executes a browser prepared in the wireless terminal 100 through an appropriate user interface (UI) provided by the main controller 10, where the user interface is implemented through an I/O unit (the display panel 5, the touch sensor 6a, the keypad 6b, and so on) embedded in the wireless terminal 100. If the user selects one remote content provided by a particular server, for example, the content server 12 illustrated in the figure and requests the selected content through the browser, a request compliant with communication protocol (for example, an HTTP Request for the URL of “http://vod.airplug.com/video/movieABC.mp4”) according to the user request is sent to the operating system 100a. The operating system 100a then transmits the received request compliant with communication protocol through hardware resources (the cellular codec 1b/the cellular modem 1a, or the Wi-Fi codec 2b/the Wi-Fi modem 2a) for the currently connected wireless network (namely, the network from which an access IP address has been allocated). Accordingly, if a response from the content server 12, for example, data related to the selected content is duly received over the network through which the request was transmitted, the response is provided to the browser.

Because the wireless terminal 100 is able to connect to multiple wireless networks altogether, it may have been connected to both of the cellular network 11a and the Wi-Fi network in a certain given communication environment. That is, multiple access IP addresses IP1, IP2 may have been allocated to the wireless terminal 100 as illustrated in FIG. 1. In such case, the operating system 100a transmits the received request through hardware resources for the network set to default.

The response received by the browser includes, in addition to the content data transmitted by the content server 12, information such as description information about the corresponding content file, for example, MIME (Multipurpose Internet Mail Extensions) type and total size of the content data, etc. that are provided in compliance with a protocol format. Therefore, the browser executes the media player 110, i.e., an app associated with the MIME type written in the received response. The association with the media player 110 can be also made by the file extension rather than the MIME type. Activating the media player 110, the browser delivers the URL, which has caused the response, or a request compliant with communication protocol prepared according to the URL, for example, an HTTP Request or RTSP/RTP Request to the media player 110 through a calling argument.

Up to this point, it has been assumed that the process of executing the media player 110 is carried out by a browser that is commonly used. It should be noted, however, that the media player 110 can be executed by various apps besides the browser. In other words, if access information, for example, URL targeting a particular remote content is selected while an arbitrary app is running, the arbitrary app can execute the media player 110 by carrying out the same process as done by the aforementioned browser. In other case, after the media player 110 is executed without involving an argument of URL or a request compliant with communication protocol, it may receive or select a URL directly from a user through the user interface. Then, the arbitrary app notifies the data transceiver 112 of the URL received or selected directly or a request compliant with communication protocol drawn up from the URL.

Once the media player 110 is executed, the receiving controller 113 allocates the receiving buffer 113a and transmission buffer 113b within the memory 7, and shares each of the allocated buffers 113a, 113b with the media data processing unit 111 and the data transceiver 112. If a calling argument is received as aforementioned at the execution, the calling argument is notified to the receiving controller 113.

The receiving controller 113 delivers the notified calling argument, namely the request compliant with communication protocol to the data transceiver 112. The data transceiver 112 requests the operating system 100a to create a new communication socket while providing the received request. At this time, the request for socket creation is intended to target a communication network set to default for data service, a currently-connected single network, or a particular one among currently-connected multi networks. To target a certain network, the data transceiver 112 refers to network connection information that is returned from the operating system 100a in response to query thereto. Since the network connection information includes an access IP address and connection type (for example, 3G mobile phone network and Wi-Fi network) in case the wireless terminal 100 is connected to at least one network, the request for creating a socket can target an intended network by specifying the connection type for or the access IP address associated with a network to use now.

As explained above, the wireless terminal 100 may have been connected to multiple networks in a given communication environment as illustrated in FIG. 1 because it can be connected to a plurality of wireless networks altogether. However, since the concept and subject, or technical idea of the present invention is directed to a receiving control method to be applied when the network usage is switched from a single-network using to multi-network using, it is assumed, for the convenience of descripting the present invention, that the requests compliant with communication protocol demanding content data individually are being transmitted through a single network now so that the content data is to be received through the single network even in the multi-network connected state at present. But, the assumption of data receiving through a single network is not kept to be applied while data of a concerned content is entirely received. Rather, the assumption is for an arbitrary time interval before necessary switching to multi-network using. In other words, not to mention a time interval before switching to multi-network using from single-network using for the first time with respect to a given remote content, the above-mentioned assumption can be also applied to another time interval before switching to multi-network using again after the network usage was changed from multi-network using to single-network using.

The operating system 100a ascertains the information (for example, protocol information, and name or IP address of a host field written in the request) carried by the request complaint with communication protocol, and establishes with the content server 12 a TCP connection to be identified by the ascertained information and a local IP address (IP:port) that is constructed by adding a port number to the access IP address which is assigned from the default or targeted network wherein the port number has been allocated by the operating system 100a to the data transceiver 112 (In other case, the data transceiver in this context may be replaced with the media player 110) that has requested creation of a socket. Once the TCP connection is established successfully, the operating system 100a creates a socket 22 in connection with the TCP connection and returns the identifier of the created socket 22 to the data transceiver 112 in response to the request for creating a socket.

When the identifier of the created socket 22 is returned, the data transceiver 112 transmits again the previously provided request compliant with communication protocol to the content server 12 through the socket 22 indicated by the identifier, and receives the response received previously by the browser through the newly created socket 22. The data transceiver 112 reads data of the response received through the socket 22 and moves it into the receiving buffer 113a. At the same time, the transceiver 112 also delivers a part of the response, for example, some head data of the response to the receiving controller 113 together with information about the connection type relevant to the socket 22 through which the response is received.

Meanwhile, the browser, at the same time as the media player 110 is executed, may close the socket 211 or transmit a request compliant with communication protocol for suspending transmission of the response data through a previously created socket 211 through which the response data is being received.

Said some head data delivered from the data transceiver 112 to the receiving controller 113 has to be enough size to include metadata about a content file being received as the response. The metadata may include media information, for example, playback duration, etc. extracted from the head data of the content file besides the aforementioned file description information provided in compliance with the protocol format for transferring a content file. The receiving controller 113 determines, with reference to the metadata, whether the content data being currently received as the response satisfies a pre-specified condition, and if the pre-specified condition is satisfied, the receiving controller 113 conducts preparing operations for controlling to receive data in the multi-network using mode. The pre-specified condition may include one condition that a received content is a specific attribute, e.g., video, its size is larger than a preset value, and the playing manner thereof is supportable to immediate playing such as streaming.

The aforementioned preparing operations to be conducted by the receiving controller 113 comprises: storing the request compliant with communication protocol having brought about the response in order to use its information later; ascertaining the type of a wireless network through which data of the response is being received at present; continuing to count total data with respect to the response that has been received until now; and monitoring a dynamic state of buffered data in the receiving buffer 113a in which the received data of the response is being stored at present. The dynamic state of the buffered data is related to the amount of currently-buffered data or change rate (increase or decrease speed) of the buffered data, etc. The counted total data ‘Arb_DataS’ during being received can be converted to a corresponding time interval ‘Arb_DataT’ in accordance with the following Eq. [1].

Arb_DataT=Arb_DataS×(P_TIME/file_{—}D) Eq. [1]

where the variable ‘file_D’ is the total size of a content file being received, and the variable ‘P_TIME’ is playback duration of the content file that is ascertained from the received metadata.

In the event that a time value has to be applied in the embodiments of the present invention, the amount of data corresponding to a given time value is calculated by using Eq. [1] reversely. Thus, in the embodiments of the present invention explained in this specification, if given physical quantities to be compared, associated, or calculated each other are different in physical unit, for example, time interval and the amount of data related to playback, they are compared after either one of them is converted to a quantity of the same unit as the other one by applying Eq. [1]. Because a given value can be converted to the same physical quantity of the other unit by Eq. [1], a certain value will be used without clarifying whether it is about time or the amount of data in the detailed explanations or in drawings related to the embodiments of the present invention.

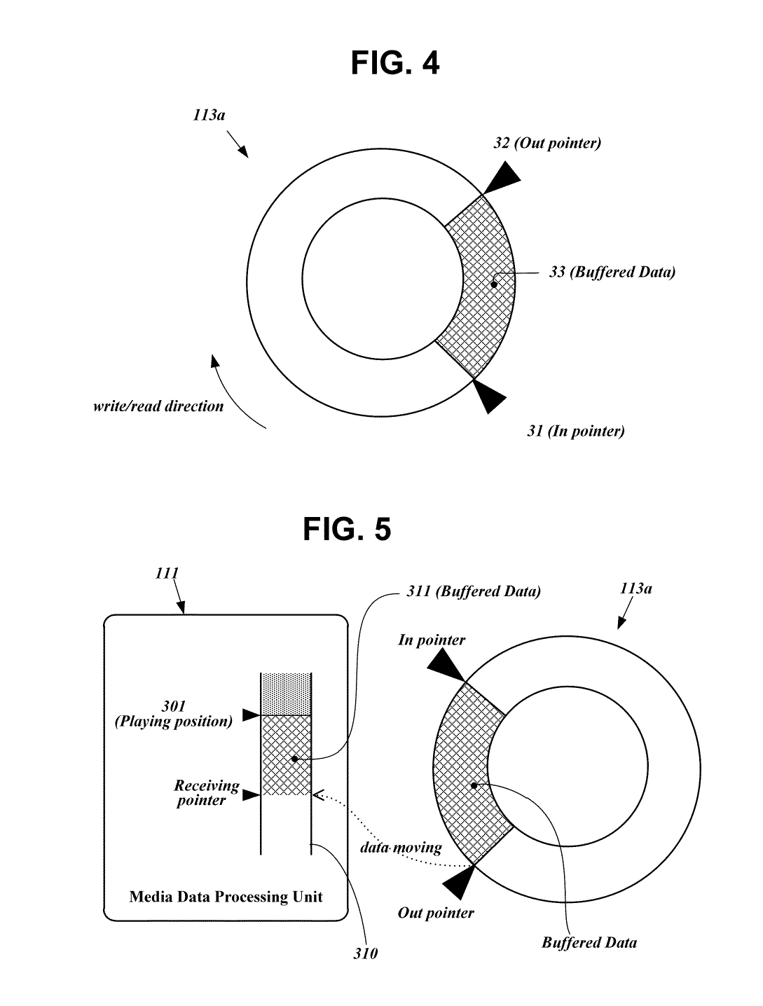

In one embodiment of the present invention, the receiving buffer 113a has the FIFO (First-In First-Out)-typed circular structure as illustrated in FIG. 4. The data transceiver 112 updates an in-pointer 31 after writing data from a location pointed by the in-pointer 31, and the media data processing unit 111 updates an out-pointer 32 after retrieving data from a location pointed by the out-pointer 32. The media data processing unit 111 has no additional buffering storage so that it makes data be decoded immediately after data is retrieved from the receiving buffer 113a. In this case, the receiving controller 113 regards the amount of data 33 lying from the in-pointer to the out-pointer as the amount of buffered data. As shown in FIG. 5, if the media data processing unit 111 has a buffering structure 310 of which size is larger than a threshold, e.g., one second that is calculated from the current decoding (or playing) position 301, the receiving controller 113 monitors the amount of the currently-buffered data in consideration of the amount of data 311 buffered in the media data processing unit 111. Consequently, irrespectively of what element of the above-mentioned ones buffers the received data until decoding, the data lying from the current playing position 301 or therearound being outputted as visual signal to the last position of the received data is monitored to know the amount of buffered data in the embodiments of the present invention. Based on such technical concept, the amount of buffered data and the buffered data is called ‘the amount of unprocessed data’ (or ‘the unprocessed amount’) and ‘the unprocessed data’ respectively in this specification because it is still before being processed for decoding. Naturally, the method to monitor the unprocessed amount may yield a small error in the exact amount of unprocessed data. If data buffered for a moment in other elements other than the receiving buffer 113a is relatively small in comparison with data buffered in the receiving buffer 113a, only the data buffered in the receiving buffer 113a may be considered as the amount of unprocessed data in another embodiment of the present invention.

In the meantime, the media data processing unit 111 retrieves content data, which is stored in the receiving buffer 113a by the data transceiver 112, in sequential order, determines a decoding system on the basis of encoding information of data recorded in the header thereof, and decodes the content data partially or completely in compliance with the determined decoding system. In the case of partial decoding, the decoder 110a is also configured with the determined decoding system by the media data processing unit 111. The partial decoding may be, for example, extraction of media packets in units of blocks, pictures, or GoP (Group of Pictures). In the partial decoding case, the media data processing unit 111 requests the decoder 110a to decode the extracted media packets while feeding them to the decoder 110a, thereby outputting an audiovisual signal corresponding to the decoded media packets. The video data decoded completely by the media data processing unit 111 is applied to the display driving unit 4 through the operating system 100a to be outputted as visual signal.

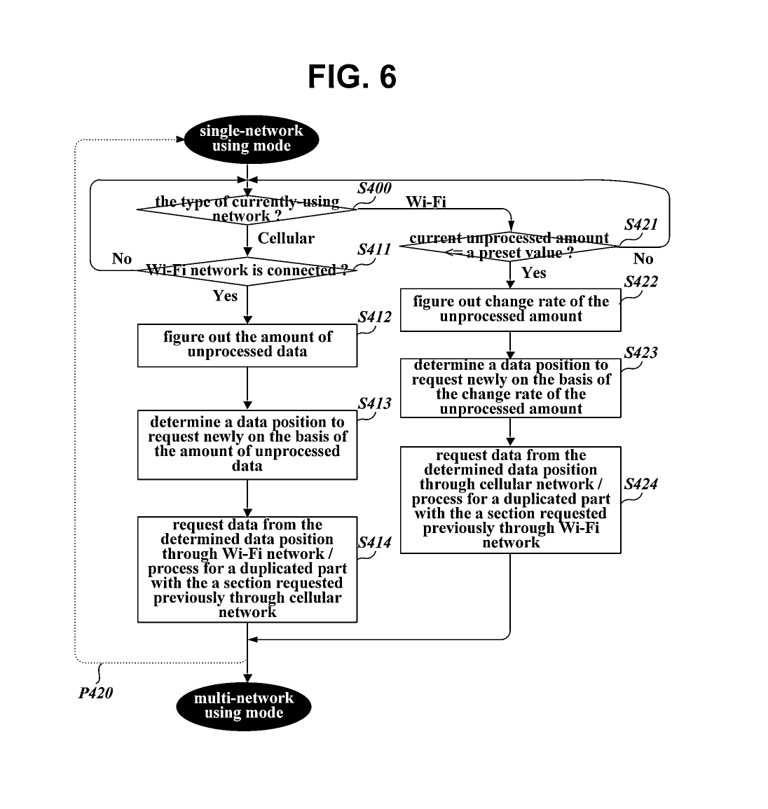

If another wireless network besides the wireless network through which the content data is being received becomes available or said another wireless network is requested for joint use while the content data provided to the media data processing unit 111 is being outputted after decoding as explained above, the wireless terminal 100 is switched from the single-network using mode (it may be abbreviated ‘single mode’ hereinafter) to the multi-network using mode (it may be abbreviated ‘multi mode’ hereinafter) as illustrated in FIG. 6. In the process for the mode switching, the receiving controller 113 determines, on the basis of the type of currently-using wireless network and the state of unprocessed data (for example, the amount of unprocessed data or changing rate of the amount of unprocessed data, etc.), a data position from which data is requested to be received through said another wireless network. In what follows, explained in detail are the methods to determine a data position to request for reception therefrom through said another wireless network in the mode switching process illustrated in FIG. 6.

The receiving controller 113 ascertains the type of a wireless network, which is being used at present by the data transceiver 112 to receive data of the selected content, based on information about connection type relevant to a socket that is received previously from the data transceiver 112, S400. For instance, it is determined whether a currently-using wireless network is a cellular or a Wi-Fi network.

If the wireless network being used to receive content data is the cellular network 11a, it is checked whether another wireless network, e.g., the Wi-Fi network 11b is being connected S411. In other words, it is checked whether an access IP address is being allocated from an arbitrary AP (Access Point) providing the Wi-Fi network 11b. The allocated access IP address can be known from current connection state information to be returned from the operating system 100a when calling a corresponding API provided by the operating system 100a. In the event that the Wi-Fi network 11b is connectable, an automatic procedure to connect thereto, namely requesting for an access IP address and being allocated therewith may be optionally conducted based on a set configuration or manipulation entered through the proper UI (User Interface) provided by the main controller 10 of the wireless terminal 100. Instead of checking periodically whether the Wi-Fi network is accessible, the receiving controller 113 may request the operating system 100a to register as a notifying target of an event that will be generated in case of being connected to the Wi-Fi network successfully. After such registration, the receiving controller 113 could be notified via the event by the operating system 100a the moment the wireless terminal 100 is connected to the Wi-Fi network.

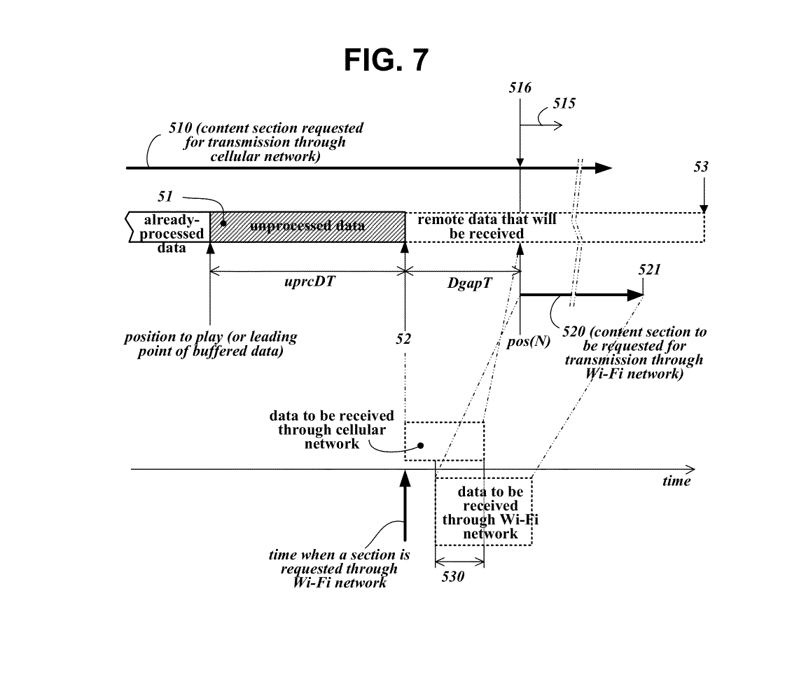

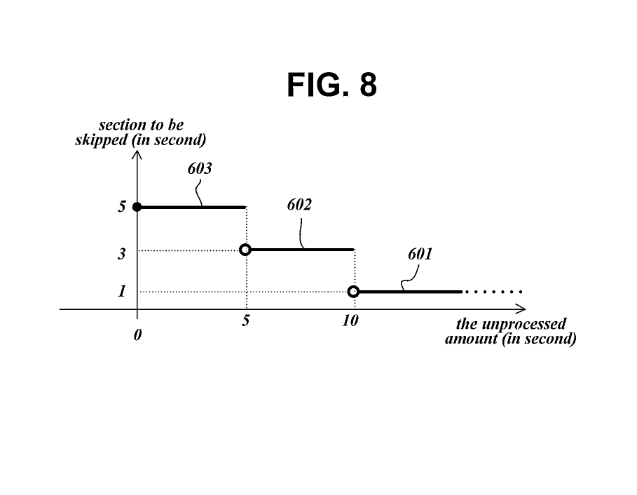

If connection to the Wi-Fi network 11b is noticed, the receiving controller 113 figures out the current amount of unprocessed data from the information about the dynamic state of the unprocessed data that is being monitored S412. That is, the receiving controller 113 figures out the amount of data buffered in the receiving buffer 113a that is not retrieved by the media data processing unit 111 yet, or the amount of data lying from the data position decoded now by the media data processing unit 111 to the last data position of the stored data in the receiving buffer 113a. After the current amount of unprocessed data is ascertained, the receiving controller 113 determines, based on the current unprocessed amount, a data position from which data receiving through the newly-connected Wi-Fi network 11b is started 5413. FIG. 7 is a figure to give better understanding of such position determination. As illustrated, a section ‘DgapT’ to skip (called ‘skip section’ hereinafter) from the last position 52 of the currently received data is determined depending upon the amount ‘uprcDT’ of unprocessed data 51 (the term of ‘amount’ is used as a meaning that also includes a corresponding time interval to be derived from Eq. [1] as aforementioned). FIG. 8 shows an example of rules to be used in determining the skip section ‘DgapT’. In the example of FIG. 8, if the amount ‘uprcDT’ of unprocessed data is above 10 seconds 601, the skip section ‘DgapT’ is determined to 1 second. If from 10 to 5 seconds 602, it is determined to 3 seconds and if below 5 seconds 603, determined to 5 seconds. The exemplary numerical values and determining rule are only for a simple example of the general rule that the size of the skip section ‘DgapT’ should be larger in case of the amount ‘uprcDT’ of unprocessed data being small than in case of the amount of unprocessed data being large under the condition that other wireless network to use newly is the Wi-Fi network 11b. Any numerical value and/or any rule could be used to embody the concept and principle of the present invention if only the above-mentioned general rule was obeyed.

As a result of communication policy or service billing policy of a communication operator who is providing a wireless data service, users can access the Wi-Fi network 11b for free. Even though the services zones, one of which is provided by the Wi-Fi network 11b, are scattered and narrow so that broad coverage is not provided, each service zone, if available, can provide high speed data service in general. Therefore, in view of users, it is advantageous to use the Wi-Fi network more than other wireless networks if the Wi-Fi network is available. In particular, in a situation that additional fee will be charged, besides a fixed cost, if using the currently-connected cellular network 11a from now on, using Wi-Fi network would be much more advantageous to users. The term of ‘fixed cost’ is used to mean the already-fixed cost which a user has to pay due to using data service until now irrespectively of whether there is future use. Thus, to make the skip section ‘DgapT’ as short as possible is advantageous in the event that the Wi-Fi network 11b becomes available newly because entire or a part of remote data right after the skip section will be received through the newly-connected Wi-Fi network 11b. However, data receiving in response to transmitted requests through the Wi-Fi network may be delayed depending on the communication state of the newly-using Wi-Fi network 11b. If such delay happens in the case that the current unprocessed amount is too small, video being played may be interrupted or frozen due to depletion of data to provide the media data processing unit 111. Furthermore, because actual service quality provided by the Wi-Fi network 11b can be known only in the connected state, it can not be premised that service quality enough to use is guaranteed after being connected thereto. Therefore, the size of the skip section ‘DgapT’ is determined relatively larger in case of the current unprocessed amount being small than in case of large. However, because advantage of using the Wi-Fi network dilutes if the size of the skip section is determined to be excessively large, the skip section is determined as explained with the above example.

If the skip section ‘DgapT’ is determined as explained before, the receiving controller 113 draws up a request compliant with communication protocol which demands data of a corresponding content from a target position ‘pos(N)’ just after the determined skip section ‘DgapT’. The target position ‘pos(N)’ can be calculated by adding the size of the determined skip section ‘DgapT’ to the total size of the currently-received data because the receiving controller 113 knows the last data position 52 on the received content data from the aforementioned continuous count of data being received for the concerned content.

When drawing up the request compliant with communication protocol which demands data from the target position ‘pos(N)’, the receiving controller 113 adds or inserts a demanding section information 721 into the previously-received request compliant with communication protocol 71 that has been delivered to the data transceiver 112. Then, the receiving controller 113 commands the data transceiver 112 to transmit the drawn-up request while delivering it to the data transceiver 112 and designating the newly-connected Wi-Fi network 11b, S414. According to this command, the data transceiver 112 requests the operating system 100a to create a socket intended for using the Wi-Fi network 11b, and transmits the received request compliant with communication protocol 72, which demands a section 520 just after the skip section ‘DgapT’, through the socket 23 created in response to the creation request. When receiving the request transmitted from the wireless terminal 100, the content server 12 transmits data of the demanded section 520 to the wireless terminal 100 over the Wi-Fi network 11b. The data of the demanded section 520 is delivered to the operating system 100a through the related hardware resources (the Wi-Fi modem 2a and the Wi-Fi codec 2b) of the wireless terminal 100, and then to the data transceiver 112 through the created socket 23 by the operating system 100a.

According to the operations explained above, data of the determined skip section ‘DgapT’ is received through the cellular network 11a through which data is being received at present while entire or a part of data right after the skip section is received through the newly-connected Wi-Fi network 11b. The data receiving through the Wi-Fi network 11b may be overlapped in time domain 530 with reception of the skip section ‘DgapT’ as illustrated in FIG. 7. Like this, if data pertaining to the same content is received through both networks simultaneously, data received using multiple networks is filled in the receiving buffer 113a in its right order on the content in accordance with the method explained below in detail.

In one embodiment of the present invention, if the amount of unprocessed data ‘uprcDT’ is equal to or greater than a predetermined threshold, e.g., 20 seconds, the skip section ‘DgapT’ may be determined to zero in size. In other words, if the unprocessed amount ‘uprcDT’ is equal to or greater than the predetermined threshold, the receiving controller 113 may create a request compliant with communication protocol that demands just from the last received data 52 and make the created request be transmitted through the newly-connected Wi-Fi network 11b as stopping reception of more data through the cellular network 11a. For stopping reception, the receiving controller 113 requests the content server 12 to stop transmission of data after the last received data 52 through the cellular network 11a, or commands the data transceiver 112 to close the socket 22 created for using the cellular network 11a. The transmission stop request acts effectively for unreceived data following the last received data 52. The receiving controller 113 notifies the data transceiver 112 of the fact that stopping transmission from the last received data 52 is requested, so that the data transceiver 112 discards the duplicated data that is received through the socket 22 until the content server 12 stop data transmission in response to the stop request.

In the meantime, if the section 520 requested newly through the Wi-Fi network 11b has a data part 515 that is duplicated on the concerned content file with the section 510 of which data is previously requested through the cellular network 11a, the receiving controller 113 conducts the operation that is necessary to stop transmission of data right after a duplication beginning position 516, S414. In the necessary operation, the receiving controller 113 may create a request compliant with communication protocol that demands to stop data transmission after the position 516, and send the created request to the content server 12. Alternatively, the moment data is received up to the position 516, the receiving controller 113 may command the data transceiver 112 to close the socket 22 which the data is received through.

The last position 521 of the section 520, 721 requested newly through the Wi-Fi network 11b can vary depending upon the multi-network using manner that is conducted by the receiving controller 113 based on communication state of each wireless network. For instance, the last position 521 may be set to an arbitrary position or the end one 53 on the remaining content data that is not received yet. In the case of an arbitrary position being set, the receiving controller 113 conducts the multi-network using manner by preparing a request document for receiving data through the cellular network 11a and commanding the data transceiver 112 to transmit to the content server 12 the prepared request document that demands a section right after the arbitrary position. In the case of the end position being set, the receiving controller 113 will switch the network usage from the multi mode to the single mode in which the Wi-Fi network 11b is used alone after data of the skip section ‘DgapT’ is entirely received P420. Even in the single mode, instead of requesting all of the remaining content data not received yet at a time, the receiving controller 113 may divide the remaining content data into segments of an arbitrary size, prepare request documents, each of which demands one of the divided segments, and transmit the request documents sequentially to the content server 12 through the currently-using network.

In the case of receiving content data in the multi mode, the receiving controller 113 determines the next section right following the section 520 that has been requested through the Wi-Fi network 11b, prepares a request document demanding the determined next section, and delivers the prepared request document to the data transceiver 112 as designating the cellular network 11a to be used. Then, the data transceiver 112 transmits the delivered request document to the content server 12 through the socket 22 created for using the designated cellular network 11a. If the socket 22 has been already closed, the data transceiver 112 requests the operating system 110a to create a new socket intended for using the designated cellular network 11a and then delivers the delivered request document through the newly-created socket so that the request document is transmitted through the cellular network 11a.

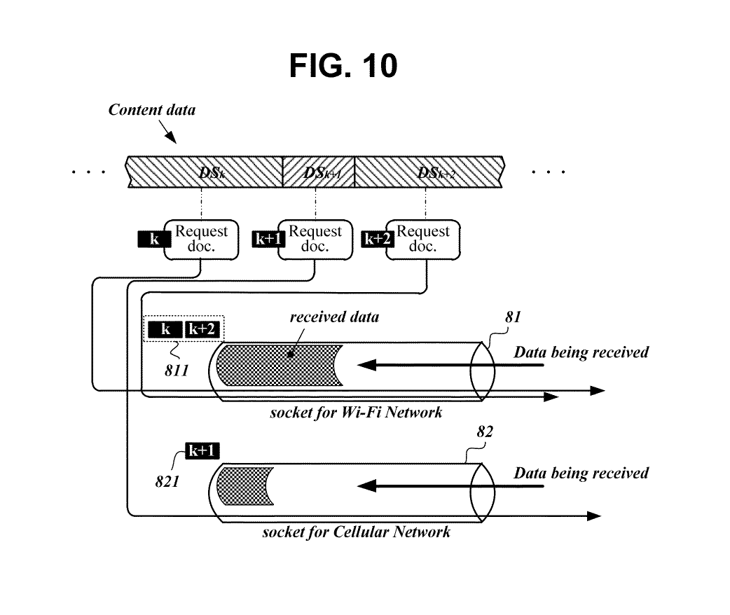

In the multi mode, because a plurality of segments divided from a concerned content are distributively received over multiple wireless networks, segment-receiving time intervals may be overlapped among the multiple networks and the received segments may be reversed in sequence. Such interval overlap may happen in the event that another section right after the skip section ‘DgapT’ is requested through other network, as explained with reference to FIG. 7. Thus, the receiving controller 113 assigns each serial number to each request document demanding a corresponding section/segment according to order of the corresponding section/segment on the concerned content (a start number is assigned to an initial request demanding entire data of a concerned content not divided), and provides the assigned serial number for the data transceiver 112 together with the corresponding request document. Then, the data transceiver 112 stores the provided serial numbers 811, 812 and request documents as socket information about each of sockets 81, 82 through which corresponding request documents are transmitted, as illustrated schematically in FIG. 10. After moving data, received through the socket 81 or 82, to the receiving buffer 113a as much as specified by the foremost request document in the stored documents in relation to the socket 81 or 82, the data transceiver 112 deletes the foremost document and its serial number from the corresponding socket information, and starts to move to the receiving buffer 113a data received through either of the sockets 81 and 82 of which socket information includes a serial number right next to the deleted serial number. This operation is explained in more detail with reference to the example illustrated in FIG. 10.

After moving data to the receiving buffer 113a as much as DSₖ that is received through the socket 81 created for using the Wi-Fi network 11b in response to the request document of serial number k, the data transceiver 112 deletes the serial number k and the request document that the serial number k is allocated to, and moves data to the receiving buffer 113a as much as DSₖ₊₁ that is received through the socket 82 created for using the cellular network 11a in response to the request document of serial number k+1. Subsequently, it moves data as much as DSₖ₊₂ that is received through the socket 81 created for using the Wi-Fi network 11b in response to the request document of serial number k+2. It is no wonder that after moving data received through each of sockets to an additional storage space, the data transceiver 112 may move the data in the additional storage space to the receiving buffer 113a again sequentially in order of the requested segments/sections as explained above.

In embodiments of the present invention, the skip section determined depending upon the unprocessed amount ‘uprcDT’ as explained above may be adjusted in size in consideration of particular variables, for example, the amount of buffered data, or actual or expected service speed of a wireless network, etc. Such adjusting of skip section is explained in detail hereinbelow.

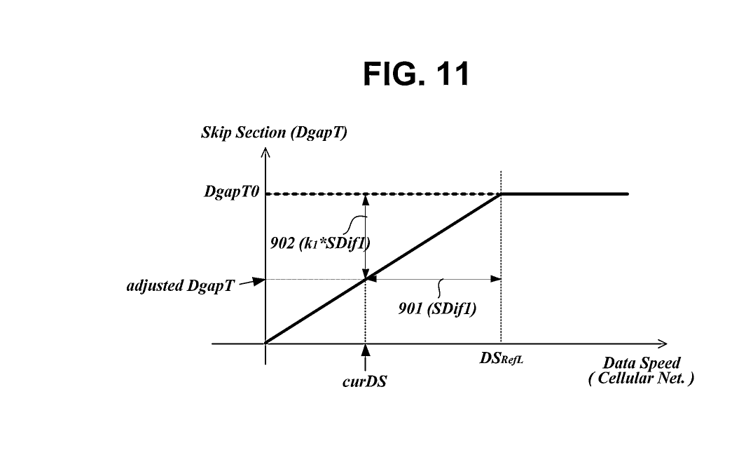

In one embodiment of the present invention, if the amount ‘uprcDT’ of unprocessed data is equal to or less than a predetermined reference, the skip section ‘DgapT’ determined in size depending upon the unprocessed amount ‘uprcDT’ is adjusted according to service speed of a currently-using network, namely, the cellular network 11a. For instance, if the current service speed ‘curDS’ of the cellular network 11a is equal to or lower than a preset reference ‘DS_{RefL}’, the skip section ‘DgapT0’ determined initially is shortened as much as a compensating value 902 that is determined in proportion to (the related proportional factor is denoted by k₁ in the figure) the difference 901 between the reference ‘DS_{RefL}’ and the current speed ‘curDS’, as illustrated in FIG. 11. The service speed of the cellular network 11a can be measured from change rate of the amount of buffered data that is continuously counted by the receiving controller 113. If the data receiving speed is low under the condition that the current unprocessed amount ‘uprcDT’ is equal to or lower than the reference ‘DS_{RefL}’, low is the possibility that data of the skip section determined depending upon the current unprocessed amount ‘uprcDT’ will be entirely received before required time to play. Consequently, it is highly probable that video interruption or freeze happens during play. Therefore, the present embodiment adjusts the determined skip section ‘DgapT’ to be shortened, if possible, to reduce the possibility of video interruption in order to decrease the amount of data to be received over the currently-using network serving at low speed. The decreased amount of data due to adjusting the determined skip section will be received through other wireless network connected newly.

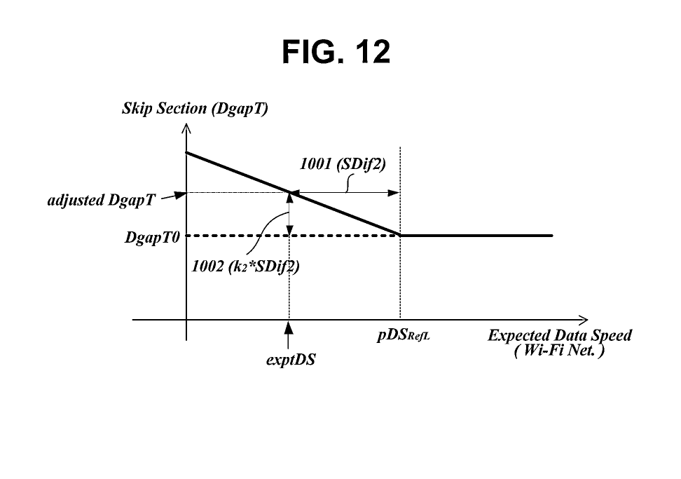

In one embodiment of the present invention, if the service speed provided by the currently-using network, namely, the cellular network 11a is equal to or higher than a predetermined speed, the determined skip section ‘DgapT’ may be adjusted in size according to an expected service speed of other wireless network, namely, the Wi-Fi network 11b connected newly. For instance, if the service speed of the currently-using network is equal to or higher than a preset satisfactory reference ‘DS_{RefH}’ (e.g., the data speed required for playing data of the concerned content being received at present), the skip section ‘DgapT0’ determined initially is lengthened as much as a compensating value 1002 that is determined in proportion to (the related proportional factor is denoted by k₂ in the figure) the difference 1001 between a preset reference ‘pDS_{RefL}’ and an expected service speed ‘exptDS’ for a currently-connected AP providing the Wi-Fi network 11b when the expected speed ‘exptDS’ is lower than a preset reference ‘pDS_{RefL}’, as illustrated in FIG. 12. If the service speed of the currently-using network is equal to or higher than the preset satisfactory reference ‘DS_{RefH}’, it means that content data is being received quite well through the currently-using network. Therefore, in the event that the speed expected, before actual use, for other wireless network to use newly is lower than the preset reference ‘pDS_{RefL}’, which implies poor service quality, the skip section ‘DgapT’ is adjusted to be longer in order that enough data may be received in more stable state through the currently-using network. The content data right after the lengthened skip section will be received through said other wireless network connected newly.

The expected service speed for an arbitrary AP providing said other network, namely, the Wi-Fi network 11b can be known from speed information provided by a particular external server by transmitting a request for the speed information to the particular external server along with a unique identification, e.g., a MAC address of an AP connected newly. The particular external server may be directly located by an access address pre-stored in the receiving controller 113 or indirectly located through redirection of one or more times invoked from a request based on the pre-stored access address. The speed information provided by the particular external server may include a current transmission speed or statistically-predicted transmission speed for the newly connected AP. The unique identification of the newly connected AP can be obtained from the operating system 100a if querying the operating system 100a because the operating system 100a stores relevant information provided by the Wi-Fi modem 2a (r11 in FIG. 2) when an effective signal is detected in the corresponding radio bandwidth. In the event that the operating system 100a or a special execution entity such as app manages a table or file of speed at which data service is used, the expected service speed can be determined from the speed table or file. For this case, the operating system 100a or the special execution entity measures a service speed, i.e., an average of data receiving speed provided by a connected network or AP while the wireless terminal 100 uses data service through the connected network or AP. The measured service speed is recorded in the speed table or file together with an unique identification of the connected network or AP. Thus, if an unique identification of a newly connected AP is found in the speed table or file, the speed recorded in connection with the found identification is used as the expected service speed to adjust the skip section ‘DgapT’ as explained above.

The embodiments of the present invention described so far are about the case that other wireless network, namely, the Wi-Fi network 11b becomes available newly under the condition of the cellular network 11a being currently used. In the following, the case of reverse order will be described.

If content data is being currently received through the Wi-Fi network 11b (S400 in FIG. 6), the receiving controller 113 checks the current unprocessed amount ‘uprcDT’ and compares it with a preset value, for example, 5 seconds periodically S421. If the checked unprocessed amount ‘uprcDT’ is equal to or smaller than the preset value, the receiving controller 113 figures out the averaged change rate of the unprocessed amount during a preset interval from the information about dynamic state of the unprocessed data that is being monitored S422. Then, it determines based on the figured-out change rate a data position which data receiving through the cellular network 11a to be used newly is started right from S423. In other words, the receiving controller 113 determines the skip section ‘DgapT’ of which data will be still received through the Wi-Fi network being currently used, in the same manner described for FIG. 7. Because addition of the change rate of the unprocessed data to the speed required for playing the concerned content being currently received results in actual data receiving speed, an operation to monitor change rate of the unprocessed data is naturally equivalent to monitoring the data receiving speed. Therefore, determination of the skip section depending upon change in data receiving speed can be rightfully equated to determination depending upon change rate of the amount of unprocessed data.

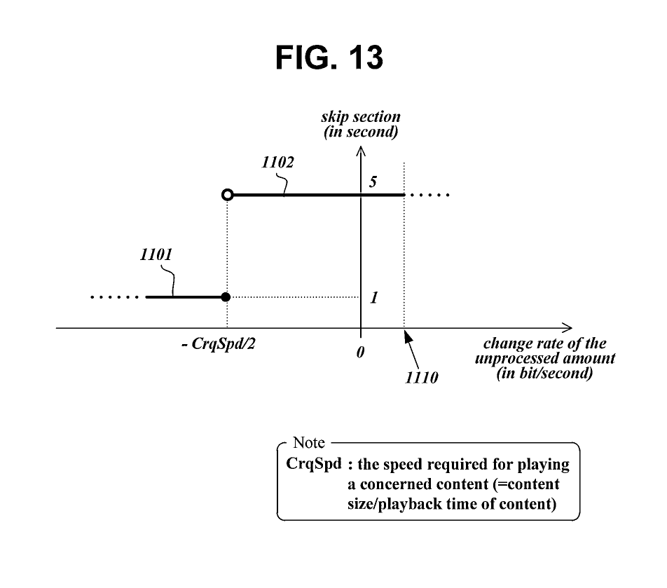

FIG. 13 shows an example of determining the skip section ‘DgapT’ for the above-mentioned case. As shown, if the change rate of the unprocessed data is negative (this means that the amount of unprocessed data is decreasing because the data receiving speed is lower than the required play speed of the content being currently received) and a ratio thereof to the required play speed is equal to or greater than a half 1101, the skip section ‘DgapT’ is determined to 1 second. If the change rate is positive or if it is negative and its ratio to the required play speed is smaller than a half as well 1102, the skip section is determined to 5 seconds. The exemplary numerical values and determining rule are for only a simple example of the general rule that the size of the skip section ‘DgapT’ should be smaller in case of the change rate of the unprocessed amount ‘uprcDT’ (equivalently, current data receiving speed) being low than in case of the change rate being high under the condition that other wireless network to use newly is the cellular network 11a. Any numerical value and/or any rule could be used to embody the concept and principle of the present invention if only the above-mentioned general rule was obeyed.

The reason to determine the skip section ‘DgapT’ as explained above is because using the cellular network 11a may charge an additional fee to users. That is, if future use of the cellular network 11a charges an additional fee besides the fixed cost at present as mentioned above, it is preferable from user's standpoint to restrain use of the cellular network 11a if possible. However, if the amount ‘uprcDT’ of unprocessed data is less than a preset reference under the condition that the Wi-Fi network 11b is being currently used, it means that the Wi-Fi network 11b is unstable state in serving wireless service. In such case, it is needed to use the cellular network 11a as soon as possible even though additional fee will be charged. The possibility of immediate use of the cellular network is very high because the cellular network is being nearly always connected to wireless terminals owing to its relatively very stable and extremely wide coverage in comparison with the Wi-Fi network of which individual service zones are restrictive. However, the amount ‘uprcDT’ of unprocessed data does not decrease very fast, the skip section ‘DgapT’ is determined to relatively large size in comparison with very fast decreasing case to restrain the amount of data to be received through the cellular network 11a because there is some room until the buffered data in the receiving buffer 113a is depleted.

In one embodiment of the present invention, the skip section may not be determined if the change rate of the unprocessed amount ‘uprcDT’ is higher than a preset reference 1110 (for example, +⅕ or +½ of the required play speed). In other words, the currently-using network, namely, the Wi-Fi network 11b continues to be used alone in data receiving without conducting an operation to use the cellular network 11a newly to request data of the concerned content therethrough. That is, the same operation as the receiving controller 113 conducts when the comparing step S421 of FIG. 6 results in ‘No’ is performed. In this single mode, checking the current unprocessed amount S421 and the change rate thereof S422 is periodically conducted as explained above, and if needed, the skip section is determined as described before. In the event that the skip section is not determined in case of the change rate being higher than the preset reference 1110 in accordance with the present embodiment, the receiving controller 113 may change the preset value used for comparison S421 of FIG. 6 that gives a chance for entering the multi mode. For example, if it is assumed that the preset value is corresponding to 5 seconds, it may be decreased to 4 or 3 seconds if the change rate is equal to or higher than the preset reference 1110. The reason to do that is because there is no need to check the change rate of unprocessed amount periodically since the change rate indicate increase of the unprocessed amount ‘uprcDT’ although the unprocessed amount is small at present. In the present embodiment, if the skip section is determined S423 on the ground that the unprocessed amount becomes below the changed preset value and the change rate becomes the preset reference 1110 as well, the receiving controller 113 restores the changed preset value to the initial value, e.g., 5 seconds.

If the skip section ‘DgapT’ is determined according to the above explanation, the receiving controller 113 prepares a request compliant with communication protocol demanding data of the concerned content from a target position right after the determined skip section, and commands the data transceiver 112 to transmit the prepared request as designating the cellular network 11a to use S424. Afterwards, if a data section to be requested newly through the cellular network 11a has a data part that is duplicated on the concerned content file with another section of which data has been previously requested through the Wi-Fi network 11b, the receiving controller 113 conducts the operation necessary to stop transmission of data following a duplication beginning position through the Wi-Fi network 11b S424.

In case of entering the multi mode due to additional use of the cellular network 11a as explained above, the receiving controller 113 divides the remaining data to receive for the concerned content into multiple segments if possible and transmits each request demanding a corresponding divided segment in order of the segments through the cellular network 11a because the additional use of the cellular network 11a may impose cost burden on user of the wireless terminal 100. If the unprocessed amount being periodically checked corresponds to considerable play interval, e.g., equal to or longer than 15 or 20 seconds during receiving the content data segment by segment, the receiving controller 113 stops using the cellular network 11a and re-enters the single mode where the Wi-Fi network 11b is used alone.

In one embodiment of the present invention, the automatic entering the multi mode on the basis of the amount of unprocessed data from the single mode of using only the Wi-Fi network can be selectively conducted depending upon a value of a configuring variable named such as ‘automatic multi-network use’. The configuring variable is set to a certain value by a user through an appropriate UI that is provided onto the display panel 5 by the media player 110. In the present embodiment, if the configuring variable named ‘automatic multi-network use’ has been set to ‘ON’, the receiving controller 113 will conduct the operation for determining the skip section based on the ascertained unprocessed amount under the condition of using only the Wi-Fi network, and if needed, other operations explained above.

Unless the various embodiments, for the content data receiving control method in the state of multiple connections to a plurality of wireless networks, described so far are not compatible with each other, the explained embodiments can be properly chosen in various ways and then combined to achieve the concept and idea of the control method.

So far, the technical principles and concept of the present invention have been described in detail by citing the Wi-Fi network of a high-speed wireless LAN as an example of a data communication network to be used together in the multi mode for data service besides a mobile phone communication network called the cellular network. However, the technical principles and concept of the present invention can be applied the same for a data communication network other than the Wi-Fi network if the data communication network provides data service for free or causes service charge, excluding the fixed cost described above, less than the cellular network (that is, imposes charge less on users). Therefore, it should be understood that the scope defined by appended claims cannot be excluded only on the ground that a data communication network to which the concept of the present invention is applied is different from the Wi-Fi network.

The embodiments of the present invention described above have been introduced for the purpose of illustration; therefore, it should be understood by those skilled in the art that modification, change, substitution, or addition to the embodiments is possible without departing from the technical principles and scope of the present invention defined by the appended claims.

What is claimed is:

1. A wireless terminal for accessing a plurality of wireless networks, comprising:
a receiver configured to receive media data from an external server through at least one connected wireless network, and provide the received data to a processing unit for decoding media data; and
a controller configured to conduct a first operation and a second operation if a requirement for using a second wireless network is satisfied while the receiver is receiving media data of a selected content from the external server through a first wireless network,
wherein the first operation is to determine a section to be skipped from a last position of unprocessed data based on information about dynamic state of the unprocessed data that has been received by the receiver but is not decoded yet, and
the second operation is to cause a transfer request, demanding data next to the determined section, to be transmitted to the external server through the second wireless network.

2. The wireless terminal of claim 1, wherein the second wireless network requires no cost to a user or a smaller cost, excluding a fixed cost, than the first wireless network when the second wireless network is used for data service, and
wherein the controller is configured to determine size of the section based on an amount of the unprocessed data that is indicated by the information about the dynamic state in such a manner that the size of the section is smaller in case of the amount of the unprocessed data being large than in case of the amount of the unprocessed data being small.

3. The wireless terminal of claim 2, wherein the controller is configured to determine the size of the section to be zero if the amount of the unprocessed data is larger than a threshold.

4. The wireless terminal of claim 2, wherein the controller is further configured to conduct, in case that the amount of the unprocessed data is smaller than a threshold,
an operation of checking data speed being received through the first wireless network and finding a compensating value based on the checked data speed; and
an operation of reflecting the found compensating value to adjust the size of the section determined based on the amount of the unprocessed data.

5. The wireless terminal of claim 4, wherein the controller is configured to find, in case of the checked data speed being lower than a first reference, the compensating value in such a manner that the size of the section is less decreased in case of the checked data speed being high than in case of the checked data speed being low when the compensating value is applied to adjust the size.

6. The wireless terminal of claim 2, wherein the controller is further configured to conduct, in case that data speed being received through the first wireless network is higher than a threshold,
an operation of finding a compensating value based on an expected service speed of the second wireless network; and
an operation of reflecting the found compensating value to adjust the size of the section determined based on the amount of the unprocessed data.

7. The wireless terminal of claim 6, wherein the controller is configured to find, in case of the expected service speed being lower than a second reference, the compensating value in such a manner that the size of the section is less increased in case of the expected service speed being high than in case of the expected service speed being low when the compensating value is applied to adjust the size.

8. The wireless terminal of claim 6, wherein the controller is configured to figure out the expected service speed from information received from an external server by providing identifying information of an access point of the second wireless network to the external server using a preset access address, or from information on receiving speeds, each of which was previously stored in the wireless terminal when the wireless terminal used data service provided through the second wireless network.

9. The wireless terminal of claim 2, wherein the requirement for using the second wireless network includes switching from a disconnected state to the second wireless network to a connected state thereto.

10. The wireless terminal of claim 1, wherein the first wireless network requires no cost to a user or a smaller cost, excluding a fixed cost, than the second wireless network when the first wireless network is used for data service, and
wherein the controller is configured to determine size of the section based on change rate of an amount of the unprocessed data that is indicated by the information about the dynamic state in such a manner that the size of the section is smaller in case of the change rate being a specific value than not in the case, the specific value being a rate at which the amount of the unprocessed data decreases faster than a threshold speed.

11. The wireless terminal of claim 10, wherein the requirement for using the second wireless network includes a first requirement that the amount of the unprocessed data is smaller than a threshold.

12. The wireless terminal of claim 11, wherein the requirement for using the second wireless network further includes a second requirement that the change rate of the amount of the unprocessed data is a value indicating that the amount of the unprocessed data does not increase faster than a reference speed, and
wherein the controller is configured to conduct both the first operation and the second operation in case that the first requirement and the second requirement are satisfied together.

13. The wireless terminal of claim 12, wherein the controller is further configured to change the threshold to a smaller value in case that the first requirement is satisfied but the second requirement is not satisfied.

14. The wireless terminal of claim 10, wherein the controller is configured to conduct, based on a control value of a pre-allocated specific variable, both the first operation and the second operation automatically if the requirement for using the second wireless network is satisfied.

15. The wireless terminal of claim 1, wherein the controller is further configured to stop, if a first data section demanded by the transfer request and a second data section are duplicated, receiving yet-unreceived data to follow a position from which the second data section is duplicated with the first data section, the second data section having been demanded by a previous request that was transmitted for receiving the media data through the first wireless network.

16. The wireless terminal of claim 1, wherein the controller is configured to convert, if a necessary physical quantity is given as a time value when determining the section, the time value to a equivalent amount of data based on mutual ratio between entire size of the selected content and playback duration thereof, and to apply the converted amount of data to determine the section.

17. A method for controlling data receiving in a state of multiple connections to wireless networks, comprising:
requesting an external server for media data of a selected content through a first wireless network;
providing the media data being received in response to the request to a processing unit for decoding media data;
determining, if a requirement for using a second wireless network is satisfied, a section to be skipped on data of the content from a last position of unprocessed data based on information about dynamic state of the unprocessed data that has been received but is not decoded yet by the processing unit; and
causing a transfer request demanding data next to the determined section to be transmitted to the external server through the second wireless network.

18. An apparatus for providing a program stored in a storage, comprising:
communication means being capable of transceiving data with an outside entity; and
a storing unit storing an application, to be run on a wireless terminal, that is transmitted through the communication means,
wherein the application includes program structures to accomplish functions, in case of being run on the wireless terminal, that comprise:
a function of receiving from an external server media data through at one or more connected wireless networks and providing the received media data to a processing unit for decoding media data;
a function of determining a section to be skipped on data of a selected content from a last position of unprocessed data based on information about dynamic state of the unprocessed data that has been received but is not decoded yet by the processing unit, if a requirement for using a second wireless network is satisfied while media data of the content is being received from the external server through a first wireless network; and
a function of causing a transfer request demanding data next to the determined section to be transmitted to the external server through the second wireless network.
